(19) United States
(12) Patent Application Publication
(10) Pub. No.: US 2024/0418897 A1
(43) Pub. Date: Dec. 19, 2024

(54) SYSTEM FOR IDENTIFYING THE PRESENCE OF A FOREIGN BODY IN A FLOWABLE MEDIUM AND CORRESPONDING METHOD

(71) Applicant: Endress+Hauser Flowtec AG, Reinach (CH)

(72) Inventors: Mohammad Sadegh Ebrahimi, Lörrach (DE); Dietmar Frühauf, Lörrach (DE); Volker Frey, Schopfheim (DE); Raphael Kuhnen, Schliengen (DE); Wolfgang Drahm, Freising (DE); Stefan Pflüger, München (DE); Anne Habermehl, Erding (DE); Hao Zhu, Freising (DE)

(21) Appl. No.: 18/705,731

(22) PCT Filed: Sep. 22, 2022
(86) PCT No.: PCT/EP2022/076337

§ 371 Date: Apr. 29, 2024

(30) Foreign Application Priority Data
Oct. 29, 2021 (DE) 10 2021 128 381.7

(51) Int. Cl. G01V 3/08; G01V 8/00; G01V 11/00

(52) U.S. Cl. CPC G01V 3/088; G01V 8/005; G01V 11/00

(57) ABSTRACT

The present disclosure relates to a system for identifying the presence of a foreign body in a flowable medium in a pipeline. The system comprises a pipeline having a line inlet section and a choke section and also comprises a first transmitting/receiving unit for the line inlet section and a second transmitting/receiving unit for the line outlet section and a superordinate unit, which system is designed to ascertain the presence of a foreign body in the medium on the basis of at least one comparison between the mean permittivity (epsilon_m,3) in the choke section and the mean permittivity (epsilon_m,1) in the line inlet section.

The invention relates to a system for identifying the presence of a foreign body in a flowable medium in a pipeline. Furthermore, the invention relates to a method for identifying the presence of a foreign body in a medium in a pipeline using a corresponding system.

In the process industry, flowable media are guided in pipelines. In areas with particularly high hygienic requirements, e.g., in the food processing industry, it is desirable to detect foreign bodies as early and reliably as possible, i.e., for example, before or while being filled into a container. The term, foreign body, comprises all solid materials which are in principle undesirable in the medium for safety and/or quality assurance reasons. These are, for example, glass shards, burrs, bone fragments, plastic and rubber pieces, gravel/stone, etc., but also undesired solid pieces in an otherwise liquid to viscous-pasty medium.

EP 18 53 900 A1 describes a system and a method for identifying the presence of foreign bodies in a medium. In this case, both microwaves and ultrasonic waves are emitted as transmitted signals into the medium by a transmitting unit configured for this purpose. The occurrence of changes in the medium, especially the presence of a foreign body, is determined on the basis of an evaluation of received signals. However, the solution presented in EP 18 53 900 A1 does not provide any way to distinguish a foreign body from a gas bubble. This is particularly challenging in the event that the gas bubble and the foreign body are in principle the same size. In contrast to foreign bodies, gas bubbles represent a harmless change in the medium.

The object of the invention is therefore to present a way to safely and reliably detect a foreign body in a medium flowing in a pipeline, and in particular also to be able to distinguish it from a gas bubble.

The object is achieved by a system for identifying the presence of a foreign body in a flowable medium in a pipeline, and a method for identifying the presence of a foreign body in a medium in a pipeline.

With regard to the system, the object is achieved by a system for identifying the presence of a foreign body in a flowable medium in a pipeline, comprising:
a pipeline having
   a line inlet section and
   a choke section adjoining the line inlet section in an anticipated flow direction,
   in which choke section, in a choking direction perpendicular to the flow direction, the cross-sectional area of the pipeline is compressed, compared to the cross-sectional area of the pipeline in the line inlet section,
   wherein the area dimension of the cross-sectional area of the pipeline in the choke section substantially matches the area dimension of the cross-sectional area of the pipeline in the line inlet section;
a first transmitting/receiving unit in the line inlet section, which is configured to introduce transmitted signals into a medium flowing in the line inlet section and to receive received signals;
a second transmitting/receiving unit in the choke section, which is configured to introduce transmitted signals into a medium flowing in the choke section and to receive received signals; and
at least one superordinate unit,
   which is designed to ascertain a mean permittivity of the medium in the line inlet section and the choke section from the corresponding received signals, and
   to determine the presence of a foreign body in the medium on the basis of at least one comparison between the mean permittivity in the choke section and the mean permittivity in the line inlet section.

The pipeline is therefore designed such that the shape of the cross-sectional area in the line inlet section differs from the shape of the cross-sectional area in the choke section, while maintaining the same area dimension.

When flowing from the line inlet section into the choke section, an object in the medium, viz., a gas bubble or a foreign body, undergoes a pressure difference.

If the object is a (usually incompressible) foreign body, the foreign body is not compressed. As a result, the relative share of the foreign body changes along a path in the cross-sectional area. For example, it is enlarged in the choking direction. As a result, the mean permittivity changes during the transition from the line inlet section to the choke section. In other words, the permittivity along a path within the cross-sectional area of the choke section differs from the mean permittivity along a path parallel thereto within the cross-sectional area of the line inlet section.

If in contrast the object is a compressible gas bubble, the gas bubble is compressed in the choke section. Due to the constant area dimension of the choke section and line inlet section, however, the relative proportion of the gas bubble along the path in the cross-sectional area remains constant. As a result, the mean permittivity along a path within the cross-sectional area of the choke section corresponds to the mean permittivity along the corresponding path parallel thereto within the cross-sectional area of the line inlet section.

In one embodiment of the system, the pipeline comprises a line outlet section adjoining the choke section in the predetermined flow direction,
wherein the cross-sectional area of the line outlet section substantially coincides with the cross-sectional area of the pipeline in the line inlet section,
wherein the system comprises a third transmitting/receiving unit in the line outlet section which is configured to introduce transmitted signals into a medium flowing in the line outlet section and to receive received signals,
and wherein the superordinate unit is configured to determine a mean permittivity of the medium in the line outlet section from the received signals.

In one embodiment of the system, the system, especially the superordinate unit, is configured to ascertain,
as a mean permittivity in the line inlet section, a permittivity averaged over a path within the cross-sectional area of the line inlet section, and,
as a mean permittivity in the choke section, a permittivity averaged over a path within the cross-sectional area of the choke section, and,
in particular as a mean permittivity in the line outlet section, a permittivity averaged over a path within the cross-sectional area of the line outlet section.

For example, the path runs substantially along the aforementioned choking direction, or also in a direction substantially perpendicular thereto in which the cross-sectional area of the choke section extends.

Since the cross-sectional area is compressed in the choking direction, the cross-sectional area—while maintaining the same area dimension of the cross-sectional area of the choke section and the line inlet section—necessarily extends in another direction.

The paths within the different cross-sectional areas (i.e., that of the line inlet section and that of the choke section) are preferably parallel to one another, and especially also the path within the cross-sectional area of the line outlet section to the first two paths.

The path along which the mean permittivity is determined is limited by a transmitting unit of the transmitting/receiving unit on the one hand, and a receiving unit of the transmitting/receiving unit on the other. The transmitting unit is therefore arranged along the path opposite the receiving unit in order to determine the mean permittivity along the path.

In one embodiment of the system, the cross-sectional area in the line inlet section is circular, and the cross-sectional area in the choke section is elliptical.

In one embodiment of the system, a transition section for adapting the different shape of the cross-sectional areas runs between the line inlet section and the choke section.

In particular, the same area dimension (i.e., that of the line inlet section and the choke section) is preferably also maintained at the transition section.

In one embodiment of the system,
in the flow direction, the length of the choke section and/or the line inlet section
   is at least as large as the diameter of the respective choke section or the line inlet section, and
      is at most as large as ten times the diameter of the respective choke section or the line inlet section,
wherein in particular the area dimensions of the cross-sectional areas of the pipeline are
   at least as large as the area dimension of a cross-sectional area of a pipeline with a nominal width of DN15, and
   at most as large as the area dimension of a cross-sectional area of a pipeline with a nominal width of DN150.

In one embodiment of the system, the first transmitting/receiving unit comprises
at least one first electrode and a second electrode,
   and the second transmitting/receiving unit comprises
at least one first electrode and a second electrode.

In this case, the mean permittivity can be determined from a capacitance and/or conductivity determinable with the electrodes. The averaging over a path takes place along the path along which the electrodes are arranged opposite each other.

In an alternative embodiment of the system to the last-mentioned embodiment, the first transmitting/receiving unit comprises:
at least one first antenna for transmitting microwaves and a second antenna for receiving microwaves,
   and the second transmitting/receiving unit comprises:
at least one first antenna for transmitting microwaves and a second antenna for receiving microwaves.

In this case, the mean permittivity can be determined from microwave received signals that have passed through the medium—for example, based upon the runtime. Preferably, these are pulsed microwave transmitted and received signals. Here, too, the averaging takes place along the path along which the antennas are arranged opposite each other.

In a development of one of the two last-mentioned embodiments, for the first transmitting/receiving unit in the line inlet section and for the second transmitting/receiving unit in the choke section,
the first electrode is arranged on the pipeline opposite the second electrode, in particular along the path, or
the first antenna is arranged on the pipeline opposite the second antenna, in particular along the path.

In another development of the system, the first transmitting/receiving unit and the second transmitting/receiving unit comprise in each case:
a plurality of first electrodes and a plurality of second electrodes or
a plurality of first antennas and a plurality of second antennas.

The plurality of electrodes or a plurality of antennas in each case serve to divide the line inlet section and the choke section into subvolumes, or to divide the respective cross-sectional area of the line inlet section and of the choke section into subareas. By means of the division, an object flowing in the medium in the pipeline can be assigned to one of the subvolumes or one of the subareas. The plurality of electrodes or a plurality of antennas can especially be arranged so as to be spaced apart from one another in such a way that a region in which an object, especially a foreign body, is substantially completely contained is in each case covered by them. This is, for example, assuming a typical, assumed size of an object, especially a foreign body, which is optionally determined by the particular application and, for example, lies between 0.2 cm-3 cm.

In this case, the object, especially the foreign body, is present only in one of the subvolumes or one of the subareas. This minimizes the influence of interfering effects when identifying the presence of the foreign body and improves the evaluation with the system according to the invention.

Preferably, the number of first and second electrodes or the number of first and second antennas of the first transmitting/receiving unit corresponds to the number of first electrodes and second electrodes or the number of first and second antennas of the second transmitting/receiving unit.

In one embodiment of the last-mentioned development, imaginary connecting lines run between pairs consisting of a first electrode and second electrode, or between pairs consisting of a first antenna and second antenna,
wherein all connecting lines in the respective cross-sectional area are arranged parallel to one another and in particular are equidistant.

The same distance preferably not only exists within the respective cross-sectional area, but the distance between all connecting lines is substantially constant in all cross-sectional areas.

Preferably, therefore, for each path that is formed by a connecting line in the cross-sectional area of the line inlet section, there is a path parallel thereto that is formed by a corresponding connecting line in the cross-sectional area of the choke section. As a result, the subareas or subvolumes are divided into the line inlet section and the choke section in the same way.

The invention also comprises all above-mentioned embodiments, mutatis mutandis, for the line outlet section which adjoins the choke section.

In one embodiment of the system, the system comprises a flow meter for determining the mass flow and/or the flow rate of the medium in the pipeline.

The flow meter serves to improve assignment of a first received signal of the first external transmitting/receiving unit and a second received signal of the second transmitting/receiving unit to the same object.

With regard to the method, the object is achieved by a method for identifying the presence of a foreign body in a medium in a pipeline with a system according to the invention. The method comprises the steps of:
transmitting transmitted signals and receiving received signals into a medium flowing in the line inlet section;
transmitting transmitted signals and receiving received signals into a medium flowing in the choke section;
determining a mean permittivity of the medium in the line inlet section, and determining a mean permittivity of the medium in the choke section;
comparing the mean permittivity in the choke section with the mean permittivity in the line inlet section;
detecting a foreign body in the medium if the mean permittivity in the choke section differs from the mean permittivity in the line inlet section.

In one embodiment of the method, this comprises the following steps:
determining a mean permittivity of the medium in the line outlet section;
comparing the mean permittivity in the choke section with the mean permittivity in the line inlet section and the mean permittivity in the line outlet section.

The line outlet section therefore serves for additional control, since the mean permittivity in the line outlet section should correspond with the mean permittivity in the line inlet section.

In one embodiment of the method, this comprises the following step:
detecting the presence of an object in the line inlet section on the basis of a determined mean permittivity of the medium,
   wherein the presence of the object is detected before the comparison of the average permittivities.

The invention will be explained further with reference to the figures, which are not true-to-scale, wherein the same reference signs designate the same features. For reasons of clarity, or if it appears sensible for other reasons, previously-noted reference signs will not be repeated in the following figures.

In the figures:

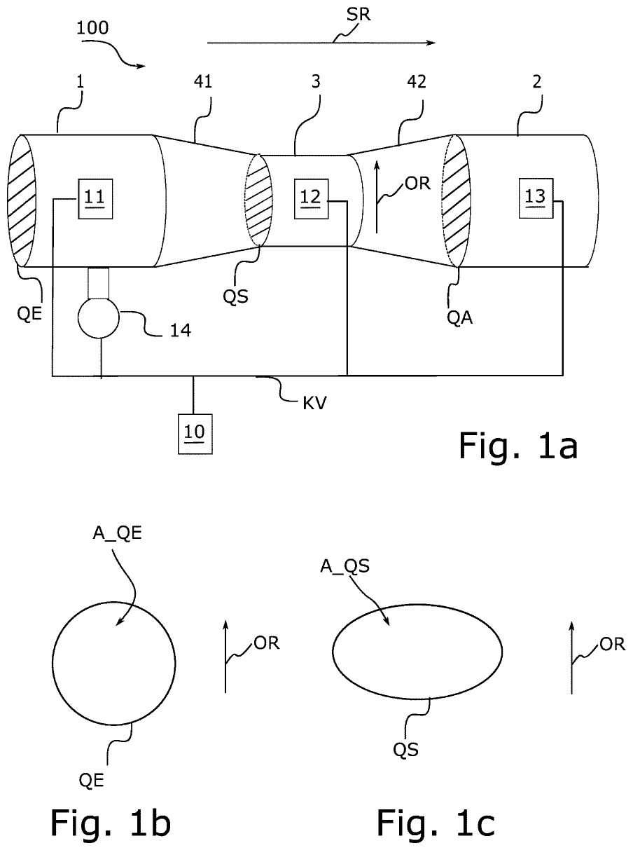

FIG. 1a shows a first embodiment of a system according to the invention with a pipeline in a side view;

FIG. 1b shows a plan view of a cross-sectional area of the pipeline in the first embodiment of the system according to the invention;

FIG. 1c shows a plan view of another cross-sectional area of the pipeline in the first embodiment of the system according to the invention;

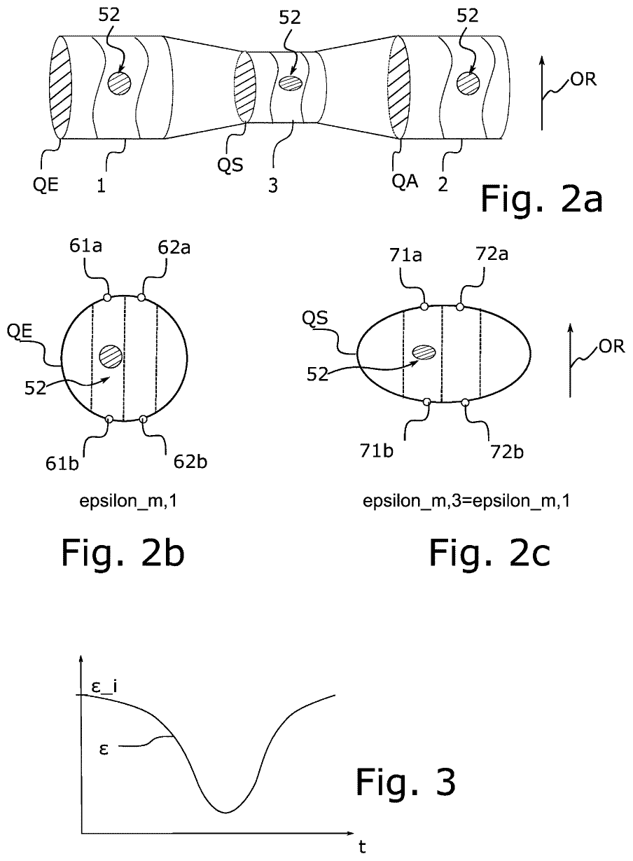

FIG. 2a shows a second embodiment of a system according to the invention with a pipeline in a side view;

FIG. 2b shows a plan view of a cross-sectional area of the pipeline in the second embodiment of the system according to the invention;

FIG. 2c shows a plan view of another cross-sectional area of the pipeline in the second embodiment of the system according to the invention;

FIG. 3 shows a schematic view of a time curve of the permittivity;

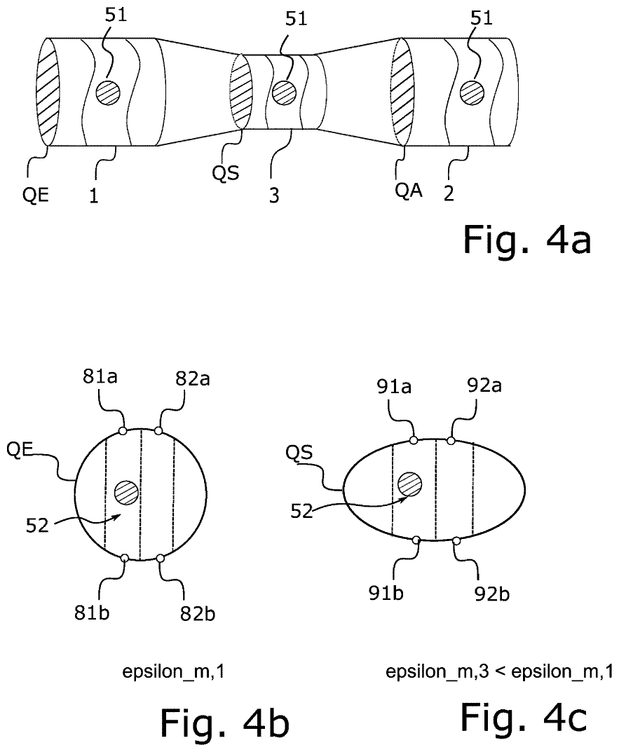

FIG. 4a shows a third embodiment of a system according to the invention with a pipeline in a side view;

FIG. 4b shows a plan view of a cross-sectional area of the pipeline in the third embodiment of the system according to the invention;

FIG. 4c shows a plan view of another cross-sectional area of the pipeline in the third embodiment of the system according to the invention; and

FIG. 1a shows a system according to the invention with a pipeline 100 through which a medium (not shown) flows in a predetermined flow direction SR. The pipeline 100 is, for example, a pipeline which conducts food—for example, as part of a filling system in the food processing industry. For example, the pipeline is arranged adjacent to a nozzle of the filling system and/or associated therewith, by means of which nozzle the medium is filled into a container. The container is then closed and sent to be sold.

The line inlet section 1 has a cross-sectional area QE, which is circular here, for example; cf. also FIG. 1b. The medium flows from the line inlet section 1 into a choke section 3, with a cross-sectional area QS. The choke section 3 is characterized in that the cross-sectional area QS is compressed in a choking direction OR which is substantially perpendicular to the flow direction SR. The cross-sectional area QS is therefore elliptical here; cf. also FIG. 1c. This compression takes place while maintaining identical area dimensions. The area measure A_QE of the cross-sectional area QE of the line inlet section 1 therefore substantially corresponds to the area measure A_QS of the cross-sectional area QS of the choke section 3 (cf. FIGS. 1b and 1c), i.e., A_QE=A_QS. In a direction of extension which is substantially perpendicular to both the flow direction SR as well as the choking direction OR, the cross-sectional area QS is therefore inevitably extended.

A line outlet section 2 adjoins the choke section 3 in the flow direction SR. Its cross-sectional area QA corresponds substantially to the cross-sectional area QE of the line inlet section 1. For this reason, A_QE=A_QS=A_QA.

In order to adapt the shape of the different cross-sectional areas QA, QS, QE, transition sections 41, 42 each run between the line inlet section 1 and the choke section 3, and the choke section 3 and the line outlet section 2. The same area measure is also preferably maintained at the transition sections 41, 42.

An associated transmitting/receiving unit 11, 12, 13 is provided in each of the sections 1, 3, 2: a first transmitting/receiving unit 11 for the line inlet section 1, a second transmitting/receiving unit 12 for the choke section 3, and a third transmitting/receiving unit 13 for the line outlet section 2 are provided. Each of the transmitting/receiving units 11, 12, 13, in their respective section 1; 3; 2, is designed to introduce transmitted signals into a medium flowing in the respective section 1; 3; 2 and to receive receiving signals. The received signals are then transmitted to a superordinate unit 10 and then evaluated. The line outlet section 2 is not essential for the invention and serves only for an additional check.

The superordinate unit 10 is connected to the transmitting/receiving units 11, 12, 13 by means of a communications link KV. The communications link KV is, for example, a wired communications link KV, e.g., an analog measurement transmission path, especially according to the 4-20 mA standard, or a wired fieldbus of automation technology—for example, Foundation Fieldbus, Profibus PA, Profibus DP, HART, CANBus. However, it can also be a communications link of a modern industrial communications network, e.g., an “Industrial Ethernet” fieldbus, in particular Profinet, HART-IP, or Ethernet/IP, or a communications network known from the communications field—for example, Ethernet according to the TCP/IP protocol.

In the event that the communications connection KV is wireless, it can, for example, be a Bluetooth, ZigBee, WLAN, GSM, LTE, UMTS communications network or else a wireless version of a fieldbus, in particular 802.15.4-based standards such as WirelessHART.

For the system according to the invention, it is completely irrelevant whether, as shown in FIG. 1a for the sake of clarity, it includes a single superordinate unit 10, or whether it has a separate superordinate unit for each of the transmitting/receiving units 11, 12, 13, which are linked to one another via communications links KV and/or are linked to another superordinate unit with a communications link KV.

The superordinate unit 10 is, for example, a higher-level control unit, e.g., a process control system with a computer or a programmed logic controller (PLC), or else a transmitter unit, in a remote or possibly non-remote variant.

Furthermore, the system also comprises a flow meter 14 by means of which the flow rate and/or the mass flow of the medium in the line inlet section 1 of the pipeline 100 can be determined. The flow meter 14 also transmits the measured values determined with the flow meter 14 to the superordinate unit 10 via the communications link KV. The flow meter 14 serves, on the basis of the flow rate and/or the mass flow, to be able to correlate a received signal received with the first transmitting/receiving unit 11 and a received signal received with the second transmitting/receiving unit 12 better with the same object 5, viz., a foreign body 51 or a gas bubble 52.

The superordinate unit 10 determines from the received signals a mean permittivity epsilon_m,1; epsilon_m,3 and epsilon_m,2 for each of the sections 1, 3, 2, and establishes on the basis of a comparison of the mean permittivity epsilon_m,1; epsilon_m,3 and epsilon_m,2 whether an object 5 present in the medium is a foreign body 51 or a gas bubble 52. In particular, the superordinate unit 10 is configured and/or the first transmitting/receiving unit 11 and second transmitting/receiving unit 12 are arranged in such a way that the mean permittivities epsilon_m,1 and epsilon_m,3 are determined along parallel paths—for example, both along the same compression direction OR.

This is shown in more detail in the following FIG. 2a to FIG. 2c for the case of a gas bubble 52 and FIG. 4a to FIG. 4c for the case of a foreign body 51. The system from FIGS. 2a to 2c and FIGS. 4a to 4c substantially corresponds to the system already shown in FIGS. 1a to 1c and differs, as shown in more detail below, only in the differently designed transmitting/receiving units 11, 12, 13, in each case in the second embodiment (FIGS. 2a to 2c) or the third embodiment (FIGS. 4a to 4c) of the system.

FIG. 2a shows, in the event that a gas bubble 52 flows from the line inlet section 1 into the choke section 3, that it is compressed or pinched in the choking direction OR in the choke section 3, in order then to then assume the previous size in the line outlet section 2 (the cross-sectional area QA of which is identical to the cross-sectional area QE of the line inlet section 1).

Here (see FIG. 2b), the first transmitting/receiving unit 11 in the line inlet section 1 comprises two first electrodes 61a, 62a and two second electrodes 61b, 62b. A first electrode 61a; 62a is arranged along an imaginary connecting line opposite a second electrode 61b; 62b. The connecting line therefore runs, for example, from the first electrode 61a to the second electrode 61b. The plurality of electrodes 61a, 61b, 62a, 62b achieves a division of the cross-sectional area QE of the line inlet section 1 into a plurality of subareas, wherein the gas bubble 52 is located in the line inlet section 1 only in one of the subareas. This is indicated by the dashed lines in FIG. 2b.

The same applies to the second transmitting/receiving unit 12 in the choke section 3; see FIG. 2c. This comprises two first electrodes 71a, 72a and two second electrodes 71b, 72b. The first electrode 71a is arranged along an imaginary connecting line opposite a second electrode 71b, and another first electrode 72a is arranged along an imaginary connecting line opposite another second electrode 72b. All connecting lines are parallel to one another. Furthermore, the distance between the connecting lines of the electrodes 61a, 61b, 62a, 62b of the first transmitting/receiving unit 11 corresponds to the distance between the connecting lines of the electrodes 71a, 71b, 72a, 72b of the second transmitting/receiving unit 12, and in each case a connecting line from the cross-sectional area QE of the line inlet section 1 is parallel to a connecting line of the choke section 3.

Via the pairs of electrodes 61a, 61b; 62a, 62b; 71a, 71b; 72a, 72b arranged opposite each other in the cross-sectional area QE, QS, an electrical capacitance and/or a conductivity present between the pairs of electrodes of the electrodes 61a, 61b; 62a, 62b; 71a, 71b; 72a, 72b is received as a receive signal by the transmitting/receiving units 11,12 and transmitted to the higher-level unit 10 (cf. FIG. 1a).

The superordinate unit 10 then determines a mean permittivity epsilon_m,2 or epsilon_m,3 of the medium, in each case for the cross-sectional area QE of the line inlet section 1 and the cross-sectional area QS of the choke section 3. This is done along the path which is bordered by the oppositely arranged pairs of electrodes 61a, 61b; 62a, 62b, 71a, 71b; 72a, 72b. The permittivity epsilon is also referred to in the prior art as a dielectric conductivity or dielectric constant.

In one embodiment, the presence of an object 5 in the medium, viz., a foreign body 51 or a gas bubble 52 in the medium flowing in the pipeline 100, is in particular determined first of all. This is based upon, for example, an evaluation of a time curve of the mean permittivity epsilon_m,1 in the line inlet section 1, as shown in more detail in FIG. 3.

The invention is particularly suitable for round objects 5, so that no or essentially hardly any turbulence or rotations of the object would be caused by the pressure difference in the transition from the line inlet section 1 into the choke section 3, which would have an undesired influence on the mean permittivity epsilon_m1; epsilon_m,3 determined along the path.

FIG. 3 shows a determined mean permittivity epsilon_m,1 as a function of time, e.g., in the cross-sectional area QE of the line inlet section 1, for the case of an object 5 flowing through the line inlet section 1. For this purpose, the mean permittivity epsilon_m,1 is determined, for example, as a location-dependent function and converted into a time-dependent function on the basis of a known and/or determined flow rate of the medium. This is done, for example, by means of the flow meter 14 mentioned above and shown in FIG. 1. Of course, it is also possible to directly analyze a location-dependent function. The time curve of the mean permittivity epsilon_m,1 is stored, for example, in a memory unit which is associated with or at least connected to the superordinate unit 10.

As a result of the object 5 appearing in the medium, the mean permittivity epsilon_m,1 decreases in the time curve in a reversed peak to a local minimum (see FIG. 3), starting from an initial permittivity epsilon_i of the medium 1, and then increases again to the initial permittivity epsilon_i. In this case, FIG. 3 already shows a time curve of a spatially integrated mean value of the permittivity along the path at whose opposite ends the pairs of electrodes 61a, 61b; 62a, 62b arranged opposite one another are arranged in the cross-sectional area QE of the line inlet section 1. For the choke section 3 as well, a time curve similar to that shown in FIG. 3 for the line inlet section 1 results for the mean permittivity epsilon_m,3.

For the case of a substantially water-based medium, the medium without an object has a mean permittivity epsilon_i of about 80, whereas a foreign body 22 (depending upon the material it consists of) typically has a permittivity epsilon in the range between 2 to 8. This lies in ranges similar to the permittivity epsilon of a gas bubble 52, as a result of which it is not always possible to distinguish between a gas bubble 52 and a foreign body 51 solely on the basis of the evaluation of the time curve of the mean permittivities epsilon_m,1 in the line inlet section 1 without further measures.

The device according to the invention or the method according to the invention solves this by comparing the mean permittivity epsilon_m,1 in the line inlet section 1 with the mean permittivity epsilon_m,3 in the choke section 3. Specifically, in the comparison, in each case a mean permittivity epsilon_m,1 is determined in the line inlet section 1, and a mean permittivity epsilon_m,3 or in the choke section 3 is determined. The mean permittivity epsilon_m is determined as the spatial mean value that can be determined by the oppositely arranged pairs of electrodes 61a, 61b; 62a, 62b or 71a, 71b, 72a, 72b. That is, along that path at whose opposite ends the oppositely arranged pairs of electrodes 61a, 61b; 62a, 62b or 71a, 71b, 72a, 72b are arranged.

By squeezing the gas bubble 52 in the choke section 3 in the choking direction OR, the mean permittivity epsilon_m,3 in the choke section 3 substantially corresponds to the mean permittivity epsilon_m,1 in the line inlet section 1; see FIGS. 2a and 2b. In this case, the flow meter 14 supports the better assignment of the mean permittivities epsilon_m,1; epsilon_m,3 to the same object 5 (here: gas bubble 52), or the presence of the virtual subvolumes or subareas (by means of the use of at least two pairs of electrodes 61a, 61b, 62a, 62b, . . . ) further minimizes the influence of interfering effects in the above-mentioned comparison.

When checking whether the mean permittivity epsilon_m,1 in the line inlet section 1 corresponds substantially to the mean permittivity epsilon_m,3 in the choke section 3, a limit value for a tolerable deviation is stored in the superordinate unit 10 and/or the memory unit associated therewith, for example. The limit value depends especially upon the specific design of the system, including the design of the transmitting/receiving units 11, 12 and/or the specific compression of the choke section 3 compressed in the choking direction OR, and/or the size of the object 5. A further specification is therefore not useful here.

The size of the object 5 can be determined beforehand. For example, the length of the object 5 (i.e., extension of the object 5 along the choking direction OR) is discernible on the basis of the width of the inverted peak from FIG. 3, and the width (i.e., extension of the object 5 along the flow direction SR) is discernible on the basis of the height of the inverted peak from FIG. 3. Alternatively or additionally, the size of the object 5 can also be optionally estimated in advance, e.g., on the basis of a preselection by a user, based upon knowledge of typical variables of potential objects 5 in the medium.

If—possibly taking into account the stored limit value—it is determined that the mean permittivity epsilon_m,3 in the choke section 3 substantially corresponds to the mean permittivity epsilon_m,1 in the line inlet section 1, the superordinate unit 10 determines that the object 5 is a gas bubble 52.

This can additionally be verified by considering received signals received by a third transmitting/receiving unit 13 arranged in the line outlet section 2. This also comprises, exactly like the first transmitting/receiving unit 11 and the second transmitting/receiving unit 12, a plurality of electrodes, analogous to that shown in FIGS. 2b and 2c (not shown here).

When the presence of a gas bubble 52 is detected, the superordinate unit 10 generates, for example, a corresponding message—for example, “detected object 5 is identified as a gas bubble 52.”

The case of a foreign body 51 is shown in more detail in FIGS. 4a to 4c. In this case, the system substantially corresponds to the system shown above in FIGS. 2a to 2c, wherein the only difference here is that the first transmitting/receiving unit 11 and the second transmitting/receiving unit 12 now comprise in FIG. 4b and FIG. 4c antennas 81a, 81b, 82a, 82b, 91a, 91b, 92a, 92b instead of the electrodes 61a, 61b, 62a, 62b, 71a, 71b, 72a, 72b from FIGS. 2b and 2c. The antennas 81a, 81b, 82a, 82b, 91a, 91b, 92a, 92b serve to transmit (e.g., antennas 81a, 82a, 91a, 92a) or receive (e.g., antennas 81b, 82b, 91b, 92b) ultrasonic waves. Preferably, these are pulsed ultrasonic waves. Just as before for the case of the electrodes from FIG. 2b, 2c, a mean permittivity epsilon_m,1 or epsilon_m,3 can be determined on the basis of the ultrasonic received signals received by the receiving antennas 81b, 82b, 91b, 92b.

Since the foreign body 51 is substantially non-compressible, the pressure difference does not cause any compression of the foreign body 51 (see FIG. 4a) during the transition from the line inlet section 1 to the choke section 3. The result of this is that the mean permittivity epsilon_m,3 determined (in the same manner as explained above) perceptively differs from the mean permittivity epsilon_m,1 in the line inlet section 1 in the choke section 3.

There may also be a second limit value for this, above which the superordinate unit 10 displays a “Foreign object 51 is detected” message.

In this way, the system or method according to the invention makes it possible to reliably identify a foreign body 51 in a medium flowing in the pipeline 100, while excluding false-positive messages.

Of course, the invention is not limited to the above-explained electrodes 61a, 61b, 62a, 62b, 71a, 71b, 72a, 72b or antennas 81a, 81b, 82a, 82b, 91a, 91b, 92a, 92b, but also comprises other possible transmitting/receiving units 11, 12, with which the determination of a mean permittivity epsilon_m,1 or epsilon_m,3 is made possible.

Furthermore, the number of electrodes 61a, 61b, 62a, 62b, 71b, 71b, 72a, 72b, 71b, 81b, 82a, 82b, 91a, 91b, 92a, 82b, 91a, 91b, 92a, 92b, 91a, 81b, 82a, 82b, 91a, 91b, 92a, 92b shown in FIG. 2b and FIG. 2c or FIG. 4b and FIG. 4c is not essential to the invention; it is completely sufficient if at least two electrodes 61a, 61b or 71a, 71b (or antennas 81a, 81b, or 91a, 91b) are each provided in the cross-sectional area QE of the line inlet section 1 and in the cross-sectional area QS of the choke section 3.

### REFERENCE SIGNS AND SYMBOLS

100 Pipeline
1 Line inlet section
2 Line outlet section
3 Choke section
41, 42 Transition sections
5 Object
51 Foreign body
52 Gas bubbles
61a, 61b, 62a, 62b, . . . Electrodes
71a, 71b, 72a, 72b, . . . Electrodes
81a, 81b, 82a, 82b, . . . Antennas
91a, 91b, 92a, 92b, . . . Antennas
10 Superordinate unit
11 First transmitting/receiving unit
12 Second transmitting/receiving unit
13 Third transmitting/receiving unit
14 Flow meter
SR Direction of flow
OR Choke direction
QE, QA, QS Cross-sectional area of 1, 2, 3
A_QE, A_QA, A_QS Area dimensions of the cross-sectional areas
epsilon_m,1 Mean permittivity in cross-sectional area of 1
epsilon_m,2 Mean permittivity in cross-sectional area of 2
epsilon_m,3 Mean permittivity in cross-sectional area of 3
KV Communications link

1-15. (canceled)

16. A system for identifying the presence of a foreign body in a flowable medium in a pipeline, comprising:
a pipeline having
a line inlet section and
a choke section adjoining the line inlet section in an intended flow direction (SR),
in which choke section, in a choking direction (OR) perpendicular to the flow direction (SR), the cross-sectional area (QS) of the pipeline is compressed, compared to the cross-sectional area (QE) of the pipeline in the line inlet section,
wherein the area dimension (A_QS) of the cross-sectional area (QS) of the pipeline in the choke section substantially matches the area dimension (A_QE) of the cross-sectional area (QE) of the pipeline in the line inlet section;
a first transmitting/receiving unit in the line inlet section, which is configured to introduce transmitted signals into a medium flowing in the line inlet section and to receive received signals,
a second transmitting/receiving unit in the choke section, which is configured to introduce transmitted signals into a medium flowing in the choke section and to receive received signals, and
at least one superordinate unit,
which is designed to ascertain a mean permittivity of the medium (epsilon_m,1) in the line inlet section and the choke section from the corresponding received signals, and
to determine the presence of a foreign body in the medium on the basis of at least one comparison of the mean permittivity (epsilon_m,3) in the choke section with the mean permittivity (epsilon_m,1) in the line inlet section.

17. The system according to claim 16,
wherein the pipeline comprises a line outlet section adjoining the choke section in the predetermined flow direction (SR),
and wherein the cross-sectional area (QA) of the line outlet section substantially coincides with the cross-sectional area (QE) of the pipeline in the line inlet section,
wherein the system comprises a third transmitting/receiving unit in the line outlet section which is configured to introduce transmitted signals into a medium flowing in the line outlet section and to receive received signals,
and wherein the superordinate unit is configured to determine a mean permittivity (epsilon_m,2) of the medium in the line outlet section from the received signals.

18. The system according to claim 16,
wherein the system is configured to determine:
as mean permittivity (epsilon_m,1) in the line inlet section, a permittivity averaged over a path within the cross-sectional area (QE) of the line inlet section, and
as mean permittivity (epsilon_m,3) in the choke section, a permittivity averaged over a path within the cross-sectional area (QA) of the choke section, and
in particular as mean permittivity (epsilon_m,2) in the line outlet section, a permittivity averaged over a path within the cross-sectional area of the line outlet section.

19. The system according to claim 16,
wherein the cross-sectional area (QE) in the line inlet section is circular, and the cross-sectional area (QS) in the choke section is elliptical.

20. The system according to claim 16,
wherein a transition section for adapting the different shape of the cross-sectional areas (QE, QS) extends between the line inlet section and the choke section.

21. The system according to claim 16,
wherein, in the flow direction (SR), the length of the choke section and/or of the line inlet section
is at least as large as the diameter of the respective choke section or of the line inlet section, and
is at most as large as ten times the diameter of the corresponding choke section or the line inlet section,
and wherein in particular the area dimensions of the cross-sectional areas (A_QS, A_QE) of the pipeline are
at least as large as the area dimension of a cross-sectional area of a pipeline with a nominal width of DN15, and
at most as large as the area dimension of a cross-sectional area of a pipeline with a nominal width of DN150.

22. The system according to claim 16,
wherein the first transmitting/receiving unit comprises:
at least a first electrode and a second electrode,
and wherein the second transmitting/receiving unit comprises:
at least a first electrode and a second electrode.

23. The system according to claim 16,
wherein the first transmitting/receiving unit comprises:
at least one first antenna for transmitting microwaves and a second antenna for receiving microwaves,
and wherein the second transmitting/receiving unit comprises:
at least one first antenna for transmitting microwaves and a second antenna for receiving microwaves.

24. The system according to claim 21,
wherein, for the first transmitting/receiving unit in the line inlet section and for the second transmitting/receiving unit in the choke section,
the first electrode is arranged on the pipeline opposite the second electrode, in particular along the path, or
the first antenna is arranged on the pipeline opposite the second antenna, in particular along the path.

25. The system according to claim 21,
wherein the first transmitting/receiving unit and the second transmitting/receiving unit each comprise:
a plurality of first electrodes and a plurality of second electrodes or
a plurality of first antennas and a plurality of second antennas.

26. The system according to claim 25,
wherein imaginary connecting lines run between pairs consisting of a first electrode and second electrode or between pairs consisting of a first antenna and second antenna, and wherein all connecting lines in the respective cross-sectional area (QE; QS) are arranged parallel to one another and in particular are equidistant.

27. A method for identifying the presence of a foreign body in a medium in a pipeline with a system, wherein the system includes:
a pipeline having
a line inlet section and
a choke section adjoining the line inlet section in an intended flow direction (SR),
in which choke section, in a choking direction (OR) perpendicular to the flow direction (SR), the cross-sectional area (QS) of the pipeline is compressed, compared to the cross-sectional area (QE) of the pipeline in the line inlet section,
wherein the area dimension (A_QS) of the cross-sectional area (QS) of the pipeline in the choke section substantially matches the area dimension (A_QE) of the cross-sectional area (QE) of the pipeline in the line inlet section;
a first transmitting/receiving unit in the line inlet section, which is configured to introduce transmitted signals into a medium flowing in the line inlet section and to receive received signals,
a second transmitting/receiving unit in the choke section, which is configured to introduce transmitted signals into a medium flowing in the choke section and to receive received signals, and
at least one superordinate unit,
which is designed to ascertain a mean permittivity of the medium (epsilon_m,1) in the line inlet section and the choke section from the corresponding received signals, and
to determine the presence of a foreign body in the medium on the basis of at least one comparison of the mean permittivity (epsilon_m,3) in the choke section with the mean permittivity (epsilon_m,1) in the line inlet section;
wherein the method comprises the steps of:
transmitting transmitted signals and receiving received signals into a medium flowing in the line inlet section;
transmitting transmitted signals and receiving received signals into a medium flowing in the choke section;
determining a mean permittivity (epsilon_m,1) of the medium in the line inlet section and determining a mean permittivity (epsilon_m,3) of the medium in the choke section;
comparing the mean permittivity (epsilon_m,3) in the choke section with the mean permittivity (epsilon_m,1) in the line inlet section;
detecting a foreign body in the medium if the mean permittivity (epsilon_m,3) in the choke section differs from the mean permittivity (epsilon_m,1) in the line inlet section.

28. The method according to claim 27, comprising the steps of:
determining a mean permittivity (epsilon_m,2) of the medium in the line outlet section;
comparing the mean permittivity (epsilon_m,3) in the choke section with the mean permittivity (epsilon_m,1) in the line inlet section and the medium permittivity (epsilon_m,2) in the line outlet section.

29. The method according to claim 27, comprising the step of:
detecting the presence of an object in the line inlet section on the basis of a determined mean permittivity (epsilon_m,1) of the medium,
wherein the presence of the object is detected before the comparison of the average permittivities (epsilon_m,3; epsilon_m,1).
